(19) United States
(12) Patent Application Publication
(10) Pub. No.: US 2013/0229828 A1
(43) Pub. Date: Sep. 5, 2013

(54) DISPLAY DEVICE OF ELECTRICAL APPARATUS

(71) Applicant: Chung-Yuan Chen, Taipei (TW)

(72) Inventor: Chung-Yuan Chen, Taipei (TW)

(73) Assignee: PRIMAX ELECTRONICS LTD., Taipei (TW)

(21) Appl. No.: 13/463,488

(22) Filed: May 3, 2012

(30) Foreign Application Priority Data
Mar. 2, 2012 (TW) 101106925

(51) Int. Cl. F21V 8/00; F21V 21/00; F21V 7/00; F21V 1/00

(52) U.S. Cl. 362/616; 362/235; 362/249.01

(57) ABSTRACT

A display device of an electrical apparatus includes a first illumination module, a second illumination module and a circuit board. The circuit board is parallel with the first illumination module and the second illumination module. A first edge of the circuit board is inserted into a gap between the first illumination module and the second illumination module. Consequently, the first light beam from the first illumination module and the second light beam from the second illumination module are blocked by the first edge of the circuit board.

### FIELD OF THE INVENTION

The present invention relates to a display device, and more particularly to a display device capable of displaying various patterns.

### BACKGROUND OF THE INVENTION

Nowadays, a casing of an electrical apparatus is usually equipped with a display device to provide a prompt function. According to the patterns shown on the display device, the user may realize the current operating status of the electrical apparatus. Generally, the display device comprises a light-emitting element and a display panel. The light-emitting element is used for emitting a light beam and directing the light beam into the display panel. When the light beam is transmitted through the display panel, a corresponding luminous pattern is visible.

Hereinafter, the structure of a conventional display device will be illustrated with reference to FIG. 1. FIG. 1 is a schematic exploded view illustrating the internal structure of a conventional display device. The conventional display device 1 comprises a backlight module 10 and a display panel 11. The backlight module 10 is disposed under the display panel 11. As shown in FIG. 1, the backlight module 10 is located at the right side of the display panel 11. The display panel 11 is a twisted nematic (TN) liquid crystal display panel. The backlight module 10 comprises at least one light-emitting element (not shown) and a light guide plate 101. The at least one light-emitting element is used for emitting at least one light beam and directing the at least one light beam to the light guide plate 101. The light guide plate 101 is used for guiding the at least one light beam to the display panel 11.

The display panel 11 comprises a first polarizing filter 111, a first glass plate 112, a plurality of liquid crystal molecules 113, a second glass plate 114, and a second polarizing filter 115. The first polarizing filter 111 is disposed over the first glass plate 112. As shown in FIG. 1, the first polarizing filter 111 is located at the left side of the first glass plate 112. The first polarizing filter 111 is a vertical filter for filtering the light beam incident into the display panel 1 and only allowing the vertically polarized light to go through. The first glass plate 112 is arranged between the first polarizing filter 111 and the liquid crystal molecules 113. In addition, a first transparent conductive film 1121 is coated on a surface of the first glass plate 112 to be used as an electrode. The first transparent conductive film 1121 is arranged in a shape of a number “8”. The second glass plate 114 is arranged between the liquid crystal molecules 113 and the second polarizing filter 115. In addition, a second transparent conductive film (not shown) is coated on a surface of the second glass plate 114 to be used as an electrode. The first transparent conductive film 1121 and the second transparent conductive film are both made of indium tin oxide (ITO). Moreover, the first transparent conductive film 1121 and the second transparent conductive film are connected to a control circuit (not shown).

The liquid crystal molecules 113 are arranged between the first glass plate 112 and the second glass plate 114. Depending on the arrangement of the liquid crystal molecules 113, the incident light is rotated at a twist angle of from 0 to 90 degrees. In addition, the twist angle is changed according to the arrangement of the liquid crystal molecules 113.

The surface of the first glass plate 112 is further plated with a first surface alignment layer (not shown). Due to the first surface alignment layer, the liquid crystal molecules 113 are arranged along the vertical direction and parallel with the surface of the first glass plate 112. Moreover, the surface of the second glass plate 114 is plated with a second surface alignment layer (not shown). Due to the second surface alignment layer, the liquid crystal molecules 113 are arranged along the horizontal direction and parallel with the surface of the second glass plate 114. The second polarizing filter 115 is disposed under the second glass plate 114. As shown in FIG. 1, the second polarizing filter 115 is located at the right side of the second glass plate 114. The second polarizing filter 115 is a horizontal filter for filtering the light beam incident into the display panel 1 and only allowing the horizontally polarized light to go through.

In a case that the backlight module 10 emits at least one light beam and directs the at least one light beam to the display panel 11, the at least one light beam is incident into the second polarizing filter 115. The horizontally-polarized portion of the at least one light beam is transmitted through the second polarizing filter 115, but the other portions of the at least one light beam are blocked by the second polarizing filter 115. The horizontally-polarized portion of the at least one light beam is then introduced into the second glass plate 114, and partially transmitted through the gaps between the horizontally-arranged liquid crystal molecules 113 which are disposed on the second glass plate 114. According to the arrangement of the liquid crystal molecules 113, a portion of the light beam is rotated by 90 degrees. The rotated portion of the light beam is transmitted through the gaps between the vertically-arranged liquid crystal molecules 113 along the vertical direction, and then left from the liquid crystal molecules 113. Next, the light beam is sequentially transmitted through the first glass plate 112 and the first polarizing filter 111. Since the portion of the light beam is propagated along the vertical direction, the portion of the light beam is transmissible through the first polarizing filter 111. If the light beam is transmitted through the first transparent conductive film 1121 of the first glass plate 112, the first transparent conductive film 1121 exhibits a bright color. Whereas, if the light beam is not transmitted through the first transparent conductive film 1121, the first transparent conductive film 1121 exhibits a dark color. In such way, the number can be shown on the display panel 11.

Moreover, as the electric field is changed, the arrangement of the liquid crystal molecules 113 is correspondingly changed. The change of the electric field is controlled by the control circuit, which is connected with the first transparent conductive film 1121 and the second transparent conductive film. That is, the control circuit may change the electric field in order to adjust the arrangement of the liquid crystal molecules 113. Since the arrangement of the liquid crystal molecules 113 is changed, the light beam is transmitted through different positions of the first transparent conductive film 1121. In such way, a different number may be shown on the display panel 11. The conventional display device 1 may be designed to display different numbers. Alternatively, the first transparent conductive film 1121 of the first glass plate 112 may be designed to have different shapes, so that the conventional display device 1 may display a number or an English letter.

However, since the display panel 11 of the conventional display device 1 is produced by stacking a plurality of plates or filters, the thickness is very large. Since the display panel 11 occupies a lot of layout space of the conventional display device 1, it is difficult to reduce the overall thickness of the conventional display device 1. Moreover, the conventional display device 1 should have the control circuit to control the arrangement of the liquid crystal molecules 113 in order to display different patterns. Since the control circuit is necessary and the display panel is complicated, the fabricating cost of the conventional display device 1 is high. In addition, the high-tech display device for displaying different patterns does not always meet the requirements of all users. In some occasions, a simple display device for displaying a simple pattern or a simple character is feasible to some users. Therefore, there is a need of providing a simply display device capable of displaying different patterns.

### SUMMARY OF THE INVENTION

The present invention provides a slim-type display device of an electrical apparatus.

The present invention also provides a display device of an electrical apparatus with a simple displaying function.

In accordance with an aspect of the present invention, there is provided a display device of an electrical apparatus. The electrical apparatus has a casing. The display device is installed on the casing. The display device includes a first illumination module, a second illumination module, and a circuit board. The first illumination module is used for emitting a first light beam. The first illumination module includes at least one first luminous pattern. The at least one first luminous pattern is visible in response to the first light beam. The second illumination module is for emitting a second light beam. The second illumination module is disposed under the first illumination module and includes at least one second luminous pattern. The at least one second luminous pattern is visible in response to the second light beam. The circuit board is arranged between the first illumination module and the second illumination module. A first edge of the circuit board is inserted into a gap between the first illumination module and the second illumination module for blocking the first light beam or the second light beam.

In an embodiment, the casing further includes a protective layer, which is disposed over the first illumination module for protecting the first illumination module. The protective layer includes a light-transmissible zone and a light-shading zone. The light-shading zone is located around the light-transmissible zone for shading the first light beam or the second light beam. The at least one first luminous pattern or the at least one second luminous pattern is visible through the light-transmissible zone in response to the first light beam or the second light beam. In addition, the light-transmissible zone has a preset light-shading percentage. f the first light beam or the second light beam is not generated, the at least first luminous pattern of the first illumination module or the at least one second luminous pattern of the second illumination module is invisible according to the preset light-shading percentage.

In an embodiment, if the first light beam or the second light beam is not generated, an external light beam from surroundings of the display device is blocked by the light-shading zone according to the preset light-shading percentage, so that the at least one first luminous pattern or the at least one second luminous pattern is invisible, wherein the preset light-shading percentage is in a range between 75% and 80%.

In an embodiment, the first illumination module includes a first light-emitting element and a first light-guiding plate. The first light-emitting element is disposed on a first surface of the circuit board for emitting the first light beam. The first light-guiding plate is stacked on the first surface of the circuit board and located at a first side of the first light-emitting element for guiding the first light beam. The second illumination module includes a second light-emitting element and a second light-guiding plate. The second light-emitting element is disposed on a second surface of the circuit board for emitting the second light beam. The second light-guiding plate is stacked on the second surface of the circuit board and located at a first side of the second light-emitting element for guiding the second light beam.

In an embodiment, the first light guide plate further includes at least one first opening, and the second light guide plate further includes at least one second opening corresponding to the at least one first opening. The at least one second opening is aligned with the at least one first opening. The casing further includes at least one positioning post corresponding to the at least one first opening and the at least one second opening The at least one positioning post is penetrated through the at least one first opening and the at least one second opening for fixing the first light guide plate and the second light guide plate on the casing.

In an embodiment, the first light-emitting element and the second light-emitting element are both side-view light emitting diodes. In addition, the circuit board is parallel with the first light-guiding plate and the second light-guiding plate.

In an embodiment, the first light guide plate is made of polycarbonate or polymethyl methacrylate, and the at least one first luminous pattern is disposed on a top surface or a bottom surface of the first light guide plate. The second light guide plate is made of polycarbonate or polymethyl methacrylate, and the at least one second luminous pattern is disposed on a top surface or a bottom surface of the second light guide plate. In addition, each of the at least one first luminous pattern and the at least one second luminous pattern includes a plurality of closely packed light-guiding microstructures.

In an embodiment, if the top surface of the first light guide plate and the top surface of the second light guide plate are both flat surfaces, the first light guide plate and the second light guide plate are made of hard and non-flexible polycarbonate or hard polymethyl methacrylate, and each of the first light guide plate and the second light guide plate has a thickness of about 1 mm. Alternatively, if the top surface of the first light guide plate and the top surface of the second light guide plate are both curvy surfaces, the first light guide plate and the second light guide plate are made of soft flexible polycarbonate or soft polymethyl methacrylate, and each of the first light guide plate and the second light guide plate has a thickness of about 0.2˜0.4 mm.

In an embodiment, a white glossy solder-proof ink layer is further formed on the circuit board for reflecting the first light beam or the second light beam, wherein the white glossy solder-proof ink layer is printed on a first surface and a second surface of the circuit board.

In an embodiment, the electrical apparatus is a mouse, a charger, a paper shredder, a Bluetooth earphone or a wireless keyboard.

In accordance with another aspect of the present invention, there is provided a display device of an electrical apparatus. The electrical apparatus has a casing. The display device is installed on the casing. The display device includes a first illumination module, a second illumination module, a circuit board, and a light-shading structure. The first illumination module is used for emitting a first light beam. The first illumination module includes at least one first luminous pattern. The at least one first luminous pattern is visible in response to the first light beam. The second illumination module is for emitting a second light beam. The second illumination module is disposed under the first illumination module and includes at least one second luminous pattern. The at least one second luminous pattern is visible in response to the second light beam. The circuit board is arranged between the first illumination module and the second illumination module. The light-shading structure is located at a first side of the circuit board and arranged between the first illumination module and the second illumination module for blocking the first light beam or the second light beam.

In an embodiment, the casing further includes a protective layer, which is disposed over the first illumination module for protecting the first illumination module. The protective layer includes a light-transmissible zone and a light-shading zone. The light-shading zone is located around the light-transmissible zone for shading the first light beam or the second light beam. The at least one first luminous pattern or the at least one second luminous pattern is visible through the light-transmissible zone in response to the first light beam or the second light beam. In addition, the light-transmissible zone has a preset light-shading percentage. f the first light beam or the second light beam is not generated, the at least first luminous pattern of the first illumination module or the at least one second luminous pattern of the second illumination module is invisible according to the preset light-shading percentage.

In an embodiment, if the first light beam or the second light beam is not generated, an external light beam from surroundings of the display device is blocked by the light-shading zone according to the preset light-shading percentage, so that the at least one first luminous pattern or the at least one second luminous pattern is invisible, wherein the preset light-shading percentage is in a range between 75% and 80%.

In an embodiment, the first illumination module includes a first light-emitting element and a first light-guiding plate. The first light-emitting element is disposed on a first surface of the circuit board for emitting the first light beam. The first light-guiding plate is stacked on the first surface of the circuit board and located at a first side of the first light-emitting element for guiding the first light beam. The second illumination module includes a second light-emitting element and a second light-guiding plate. The second light-emitting element is disposed on a second surface of the circuit board for emitting the second light beam. The second light-guiding plate is stacked on the second surface of the circuit board and located at a first side of the second light-emitting element for guiding the second light beam.

In an embodiment, the first light guide plate further includes at least one first opening, and the second light guide plate further includes at least one second opening corresponding to the at least one first opening. The at least one second opening is aligned with the at least one first opening. The casing further includes at least one positioning post corresponding to the at least one first opening and the at least one second opening. The at least one positioning post is penetrated through the at least one first opening and the at least one second opening for fixing the first light guide plate and the second light guide plate on the casing.

In an embodiment, the first light-emitting element and the second light-emitting element are both side-view light emitting diodes. In addition, the circuit board is parallel with the first light-guiding plate and the second light-guiding plate.

In an embodiment, the first light guide plate is made of polycarbonate or polymethyl methacrylate, and the at least one first luminous pattern is disposed on a top surface or a bottom surface of the first light guide plate. The second light guide plate is made of polycarbonate or polymethyl methacrylate, and the at least one second luminous pattern is disposed on a top surface or a bottom surface of the second light guide plate. In addition, each of the at least one first luminous pattern and the at least one second luminous pattern includes a plurality of closely packed light-guiding microstructures.

In an embodiment, if the top surface of the first light guide plate and the top surface of the second light guide plate are both flat surfaces, the first light guide plate and the second light guide plate are made of hard and non-flexible polycarbonate or hard polymethyl methacrylate, and each of the first light guide plate and the second light guide plate has a thickness of about 1 mm. Alternatively, if the top surface of the first light guide plate and the top surface of the second light guide plate are both curvy surfaces, the first light guide plate and the second light guide plate are made of soft flexible polycarbonate or soft polymethyl methacrylate, and each of the first light guide plate and the second light guide plate has a thickness of about 0.2˜0.4 mm.

In an embodiment, the light-shading structure is disposed on a bottom surface of the first light-guiding plate or a top surface of the second light-guiding plate. Moreover, the light-shading structure is formed by painting, spraying, printing or bonding a light-shading material on the bottom surface of the first light-guiding plate or the top surface of the second light-guiding plate.

In an embodiment, the light-shading structure is a plastic sheet, a sponge structure or a light-shading plate. The light-guiding structure is disposed within a gap between the first light-guiding plate and the second light-guiding plate and located at a first side of the circuit board.

In an embodiment, a white glossy solder-proof ink layer is further formed on the circuit board for reflecting the first light beam or the second light beam, wherein the white glossy solder-proof ink layer is printed on a first surface and a second surface of the circuit board.

In an embodiment, the electrical apparatus is a mouse, a charger, a paper shredder, a Bluetooth earphone or a wireless keyboard.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating the internal structure of a conventional display device;

FIG. 2 is a schematic perspective view illustrating the outward appearance of a display device of an electrical apparatus according to a first embodiment of the present invention;

FIG. 3 is a schematic side view illustrating the display device of the electrical apparatus according to the first embodiment of the present invention;

FIG. 4 is a schematic side view illustrating the display device of the electrical apparatus according to the first embodiment of the present invention and taken along another viewpoint;

FIG. 5 is a schematic side view illustrating the first light-emitting element and the second light-emitting element of the display device according to the first embodiment of the present invention and taken along another viewpoint;

FIG. 6 is a schematic perspective view illustrating the display device of the electrical apparatus according to the first embodiment of the present invention, in which the first luminous patterns are visible;

FIG. 7 is a schematic perspective view illustrating the display device of the electrical apparatus according to the first embodiment of the present invention, in which the second luminous patterns are visible;

FIG. 8 is a schematic perspective view illustrating the outward appearance of a display device of an electrical apparatus according to a second embodiment of the present invention;

FIG. 9 is a schematic perspective view illustrating the outward appearance of a display device of an electrical apparatus according to a third embodiment of the present invention;

FIG. 10 is a schematic side view illustrating the display device of the electrical apparatus according to the third embodiment of the present invention;

FIG. 11 is a schematic perspective view illustrating the outward appearance of a display device of an electrical apparatus according to a fourth embodiment of the present invention;

FIG. 12 is a schematic side view illustrating the display device of the electrical apparatus according to the fourth embodiment of the present invention; and

FIG. 13 is a schematic perspective view illustrating the outward appearance of a display device of an electrical apparatus according to a fifth embodiment of the present invention.

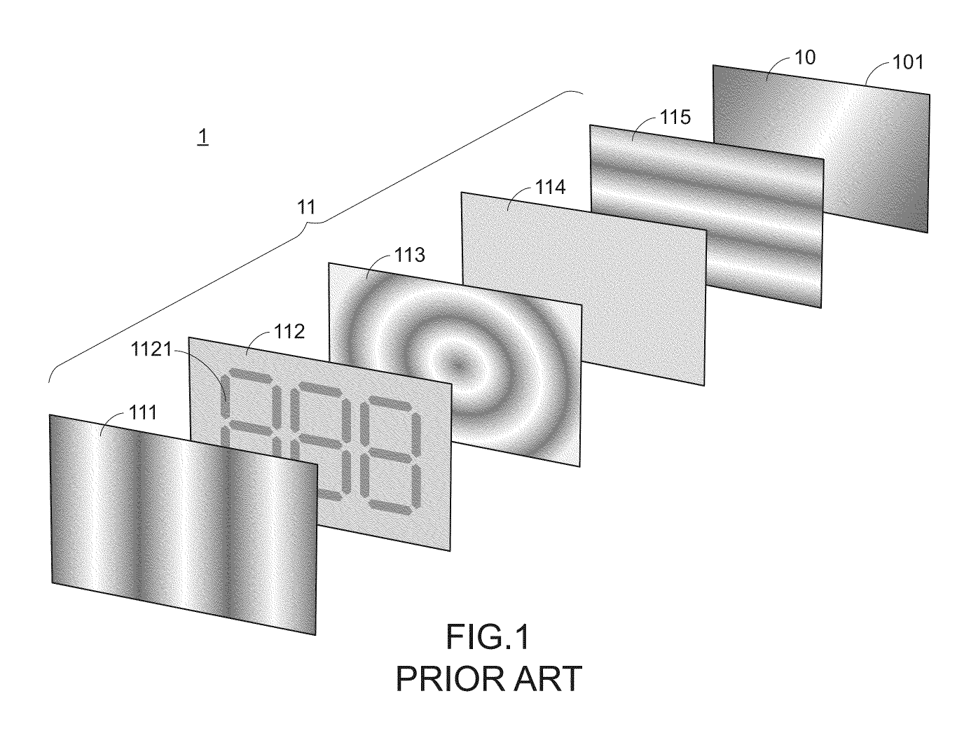

### DETAILED DESCRIPTION OF THE PREFERRED EMBODIMENT

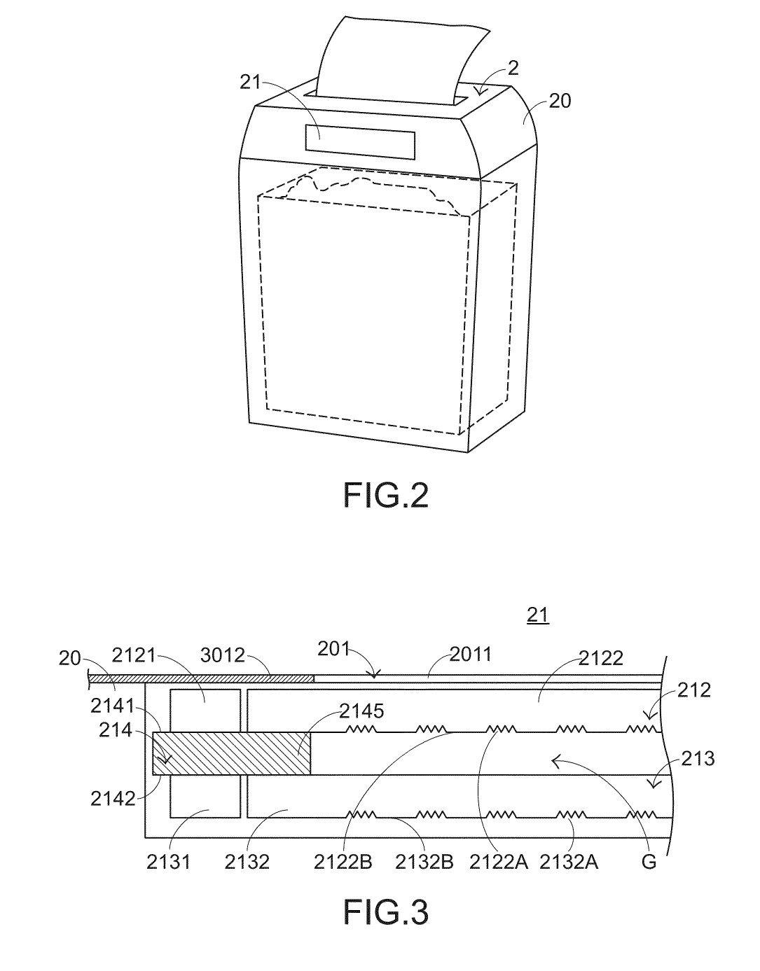

For eliminating the drawbacks encountered from the prior art, the present invention provides a display device of an electrical apparatus. FIG. 2 is a schematic perspective view illustrating the outward appearance of a display device of an electrical apparatus according to a first embodiment of the present invention. FIG. 3 is a schematic side view illustrating the display device of the electrical apparatus according to the first embodiment of the present invention.

As shown in FIG. 2, the electrical apparatus 2 comprises a casing 20 and a display device 21. The casing 20 comprises a protective layer 201. In this embodiment, the electrical apparatus 2 is a paper shredder. The protective layer 201 is integrally formed with the casing 20. As shown in FIG. 3, the display device 21 comprises a first illumination module 212, a second illumination module 213, and a circuit board 214. From bottom to top, the second illumination module 213, the circuit board 214, the first illumination module 212 and the protective layer 201 are sequentially shown.

The first illumination module 212 of the display device 21 comprises a first light-emitting element 2121 and a first light guide plate 2122. The first light-emitting element 2121 is disposed on a first surface 2141 of the circuit board 214 for emitting a first light beam (not shown). The first light guide plate 2122 is stacked on the first surface 2141 of the circuit board 214, and located at a first side of the first light-emitting element 2121 for guiding the first light beam. In addition, the first light guide plate 2122 has a plurality of first luminous patterns 2122A. The first luminous patterns 2122A are disposed on a bottom surface 2122B of the first light guide plate 2122. That is, when the first light beam is emitted by the first light-emitting element 2121, the first luminous patterns 2122A of the first light guide plate 2122 are illuminated and become visible.

Furthermore, the second illumination module 213 comprises a second light-emitting element 2131 and a second light guide plate 2132. The second light-emitting element 2131 is disposed on a second surface 2142 of the circuit board 214 for emitting a second light beam (not shown). The second light guide plate 2132 is disposed on the second surface 2142 of the circuit board 214, located at a first side of the second light-emitting element 2131 for guiding the second light beam. In addition, the second light guide plate 2132 has a plurality of second luminous patterns 2132A. The second luminous patterns 2132A are disposed on a bottom surface 2132B of the second light guide plate 2132. That is, when the second light beam is emitted by the second light-emitting element 2131, the second luminous patterns 2132A of the second light guide plate 2132 are illuminated and become visible.

In this embodiment, the first luminous patterns 2122A and the second luminous patterns 2132A are closely packed light-guiding microstructures. The light-guiding microstructures are for example closely packed microstructures (e.g. micro lenses or V-shaped notches) or closely packed dots. The light-guiding microstructures that constitute the luminous patterns may change the incidence angles of a portion of the light beam within the first light-emitting element 2121 or the second light guide plate 2132. Since the uses of the light-guiding microstructures can destroy the total internal reflection path, the light beam is refracted and transmitted through the first light-emitting element 2121 or the second light guide plate 2132. That is, the light beam is transmitted through the regions over the light-guiding microstructures, so that the first luminous patterns 2122A or the second luminous patterns 2132A are visible.

In an embodiment, the first light guide plate 2122 and the second light guide plate 2132 are both made of polycarbonate (PC), the first luminous patterns 2122A are disposed on the bottom surface 2132B of the second light guide plate 2132, and the second luminous patterns 2132A are disposed on a bottom surface 2132B of the second light guide plate 2132. Alternatively, in some other embodiments, the first light guide plate 2122 and the second light guide plate 2132 are both made of polymethyl methacrylate (PMMA). Moreover, the first luminous patterns 2122A are disposed on a top surface of the second light guide plate 2132, and the second luminous patterns 2132A are disposed on a top surface of the second light guide plate 2132.

Please refer to FIG. 3 again. The protective layer 201 is disposed over the first illumination module 212 for protecting the first illumination module 212. In addition, the protective layer 201 comprises a light-transmissible zone 2011 and a light-shading zone 2012. The light-shading zone 2012 is located around the light-transmissible zone 2012. The light-shading zone 2012 is used for shading the first light beam, the second light beam or other external light beams. In response to the first light beam or the second light beam, the first luminous patterns 2122A or the second luminous patterns 2132A are visible through the light-transmissible zone 2011. Moreover, the light-transmissible zone 2011 has a preset light-shading percentage. For example, the preset light-shading percentage is in the range between 75% and 80%. The circuit board 214 is located beside the first illumination module 212 and the second illumination module 213. In addition, the circuit board 214 is parallel with the first light guide plate 2122 and the second light guide plate 2132.

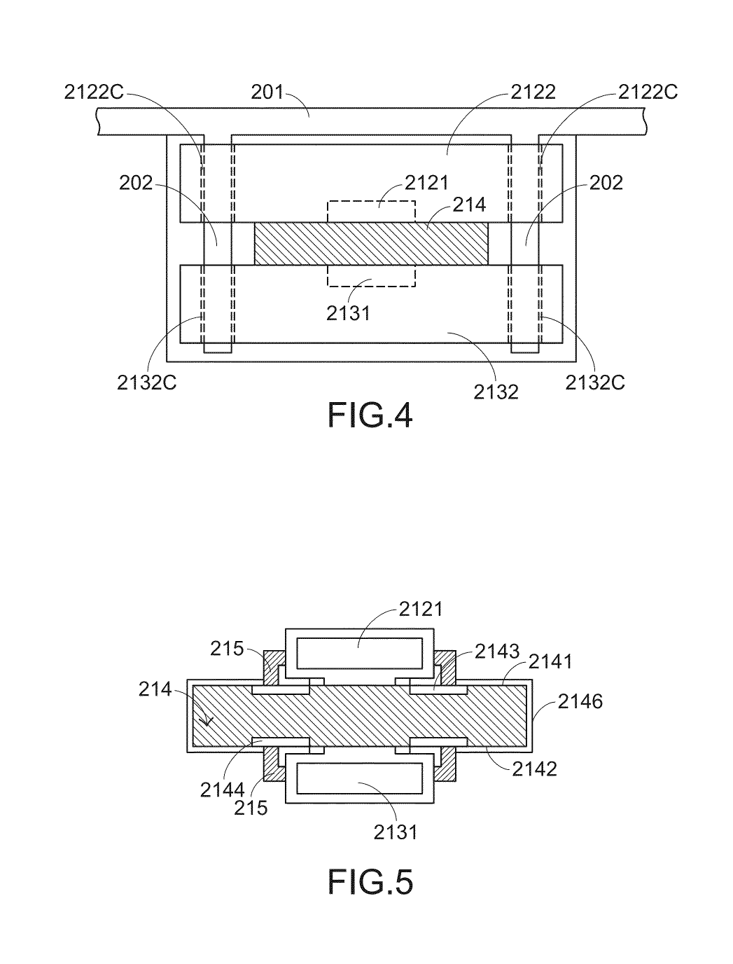

FIG. 4 is a schematic side view illustrating the display device of the electrical apparatus according to the first embodiment of the present invention and taken along another viewpoint. The first light guide plate 2122 further comprises at least one first opening 2122C. Corresponding to the first opening 2122C, the second light guide plate 2132 further comprises at least one second opening 2132C. In an embodiment, the first light guide plate 2122 comprises a plurality of first openings 2122C, and the second light guide plate 2132 comprises a plurality of second openings 2132C. The first openings 2122C are aligned with respective second openings 2132C. Moreover, the casing 20 further comprises at least one positioning post 202 corresponding to the at least one first opening 2122C and the at least one second opening 2132C. The positioning post 202 is penetrated through the corresponding first opening 2122C and the corresponding second opening 2132C, thereby fixing the first light guide plate 2122 and the second light guide plate 2132 on the casing 20.

In some other embodiments, a double-sided adhesive tape (not shown) is arranged between the first light guide plate 2122 and the casing 20. Through the double-sided adhesive tape, the first light guide plate 2122 is attached on the casing 20. Consequently, the first light guide plate 2122 is securely fixed on the casing 20, and the structural connection between the first light guide plate 2122 and the casing 20 is enhanced.

FIG. 5 is a schematic side view illustrating the first light-emitting element and the second light-emitting element of the display device according to the first embodiment of the present invention and taken along another viewpoint. The circuit board 214 has a first metallic contact 2143 and a second metallic contact 2144. The first metallic contact 2143 is disposed on the first surface 2141 of the circuit board 214. The second metallic contact 2144 is disposed on the second surface 2142 of the circuit board 214. The first light-emitting element 2121 is disposed on the first surface 2141 of the circuit board 214. In addition, the first light-emitting element 2121 is connected to the first metallic contact 2143 on the first surface 2141 through a welding material 215 by welding. In this embodiment, the welding material 215 is metallic tin. The second light-emitting element 2131 is disposed on the second surface 2142 of the circuit board 214. Similarly, the second light-emitting element 2131 is connected to the second metallic contact 2144 on the second surface 2142 through the welding material 215 by welding. As shown in FIG. 5, both of the first light-emitting element 2121 and the second light-emitting element 2131 are side-view light emitting diodes. Moreover, the circuit board 214 further comprises a white glossy solder-proof ink layer 2146. The first light beams and the second beams may be reflected by the white glossy solder-proof ink layer 2146. In an embodiment, the white glossy solder-proof ink layer 2146 is formed on the first surface 2141 and the second surface 2142 of the circuit board 214 by a printing technology.

Please refer to FIG. 3 again. The first illumination module 212 and the second illumination module 213 are separated from each other by a gap G. A first edge 2145 of the circuit board 214 is inserted into the gap G. Consequently, the first light beam from the first light-emitting element 2121 is blocked by the first edge 2145 of the circuit board 214. Under this circumstance, the first light beam is not transmitted through the gap G to influence the second illumination module 213. Similarly, the second light beam from the second light-emitting element 2131 is also blocked by the first edge 2145 of the circuit board 214. Consequently, the second light beam is not transmitted through the gap G to influence the first illumination module 212.

In a case that the first illumination module 212 and the second illumination module 213 of the display device 21 are disabled and the first light beam and the second light beam are not generated, the first luminous patterns 2122A and the second luminous patterns 2132A are not shown on the display device 21. Although no light beams are emitted by the first light-emitting element 2121 and the second light-emitting element 2131, the weak external light beams from the surroundings are possibly incident into the light-transmissible zone 2011 of the protective layer 201. Since the preset light-shading percentage of the light-transmissible zone 2011 is in the range between 75% and 80%, about 75%-80% of the light beams incident into the light-transmissible zone 2011 are absorbed by the light-transmissible zone 2011. That is, the rest (i.e. 20˜25%) of the light beams are transmitted through the first light-guiding plate 2122. After the light-guiding microstructures on the bottom surface 2122B of the first light-guiding plate 2122 are hit by the rest (i.e. 20˜25%) of the light beams, about a half of these light beams are refracted and continuously directed toward the region under the first light-guiding plate 2122 because the incidence angles of the light beams projected on the light-guiding microstructures are different. That is, only about 10% of the light beams are reflected by the light-guiding microstructures and directed toward the protective layer 201. After the light beams are reflected to the protective layer 201, portions of the light beams are absorbed by the light-transmissible zone 2011 again. Consequently, only about 2% of the light beams are transmitted through the light-transmissible zone 2011. Since the light beam intensity is too weak, the first luminous patterns 2122A and the second luminous patterns 2132A are invisible. Under this circumstance, the first luminous patterns 2122A and the second luminous patterns 2132A fail to be viewed by the user.

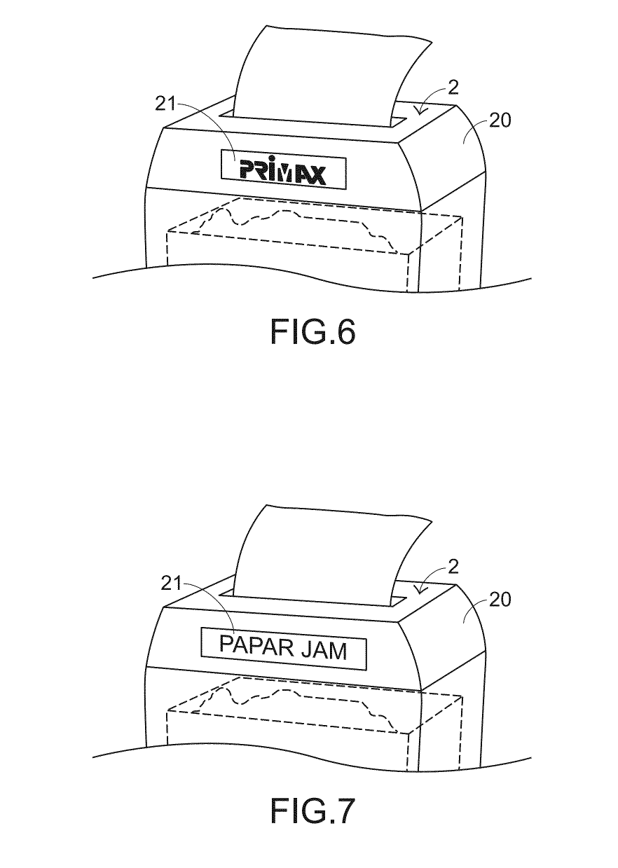

FIG. 6 is a schematic perspective view illustrating the display device of the electrical apparatus according to the first embodiment of the present invention, in which the first luminous patterns are visible. After the first illumination module 212 is enabled and the first light-emitting element 2121 is turned on, a great portion of the first light beam is laterally incident into the first light-guiding plate 2122. Moreover, a portion of the first light beam is blocked by the first edge 2145 of the circuit board 214 and reflected by the white glossy solder-proof ink layer 2146 on the surface of the circuit board 214. Consequently, the portion of the first light beam is directed into the first light-guiding plate 2122 again. When the first light beam within the first light-guiding plate 2122 is directed to the first luminous patterns 2122A that are constructed by the light-guiding microstructures, the first light beam is directed toward the region over the first light-guiding plate 2122 because the total internal reflection path is destroyed by the light-guiding microstructures. When the first light beam is directed to the light-transmissible zone 2011 of the protective zone 201, transmitted through the protective layer 201 and about 75%˜80% of the first light beam is absorbed by the light-transmissible zone 2011. That is, about 20˜25% of the first light beam is allowed to be transmitted through the light-transmissible zone 2011, and the first luminous patterns 2122A are visible through the light-transmissible zone 2011 and viewable by the user (see FIG. 6).

The operations of enabling the second illumination module 213 of the display device 21 are similar to those of the first illumination module 212, and are not redundantly described herein. That is, after the second illumination module 213 is enabled, the second luminous patterns 2132A are viewable by the user (see FIG. 7).

As shown in FIGS. 6 and 7, the first luminous patterns 2122A are arranged in a brand logo (e.g. “PRIMAX”), and the second luminous patterns 2132A are arranged in a specified character (e.g. “PAPER JAM”). For example, in a case that the first luminous patterns 2122A are shown on the casing 20, the electrical apparatus 2 is in a use status. Whereas, in a case that the second luminous patterns 2132A are shown on the casing 20, the electrical apparatus 2 is in a paper-jam status. On the other hand, if the first luminous patterns 2122A and the second luminous patterns 2132A are not shown on the casing 20, the electrical apparatus 2 is in an off status or a sleep status. That is, the operating status the electrical apparatus 2 may be realized according to the kinds of the luminous patterns.

In this embodiment, the display device 21 is installed on a flat surface of the casing 20 of the electrical apparatus 2. Correspondingly, as shown in FIG. 3, the first light guide plate 2122 and the second light guide plate 2132 have flat surfaces. In an embodiment, the first light guide plate 2122 and the second light guide plate 2132 are made of hard and non-flexible polycarbonate. In addition, the thickness of each of the first light guide plate 2122 and the second light guide plate 2132 is about 1 mm.

From the above discussions, the overall thickness of the display device 21 of the electrical apparatus 2 is the sum of the thicknesses of the circuit board 214, the first light guide plate 2122 and the second light guide plate 2132. The thickness of the first light guide plate 2122 is substantially identical to the thickness of the light guide plate 101 of the conventional backlight module 10. In comparison with the overall thickness of the conventional display device 1 (including the display panel 11), the thickness of the display device 21 of the electrical apparatus 2 according to the present invention is largely reduced. Consequently, the display device 21 of the electrical apparatus 2 of the present invention is slim. Furthermore, it is not necessary to install an additional control circuit in the display device of the present invention to control the luminous patterns. As a consequence, the display device 21 of the electrical apparatus 2 of the present invention is more cost-effective.

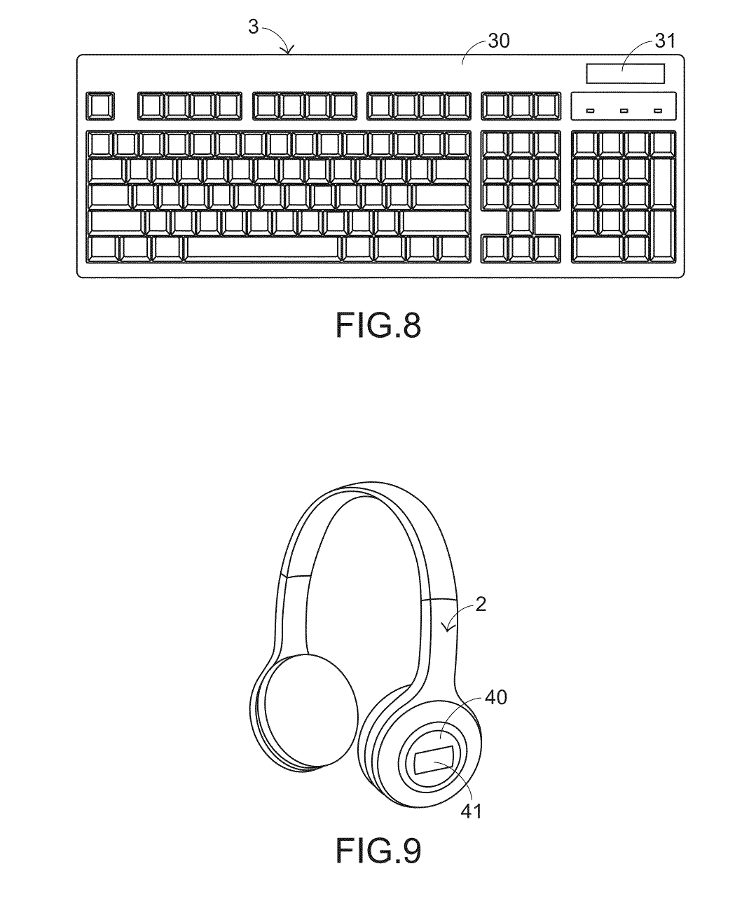

The present invention further provides a second embodiment. FIG. 8 is a schematic perspective view illustrating the outward appearance of a display device of an electrical apparatus according to a second embodiment of the present invention. As shown in FIG. 8, the electrical apparatus 3 comprises a casing 30 and a display device 31. In this embodiment, the electrical apparatus 3 is a wireless keyboard. The display device 31 is installed on a flat surface of the casing 30 of the electrical apparatus 3. The configurations of the display device 31 are similar to those of the display device 21 of the first embodiment, and are not redundantly described herein. The display device 31 is used for displaying the brand logo of the wireless keyboard 3 or the pairing status of the wireless signal receiver (not shown) of the wireless keyboard 3. For example, the first luminous patterns are arranged in a brand logo (e.g. “PRIMAX”), and the second luminous patterns are arranged in a specified character (e.g. “PAIRING”) to denote that the pairing operation of the wireless signal receiver of the wireless keyboard 3 is being performed. On the other hand, if the first luminous patterns and the second luminous patterns are not shown, the electrical apparatus 3 is in an off status.

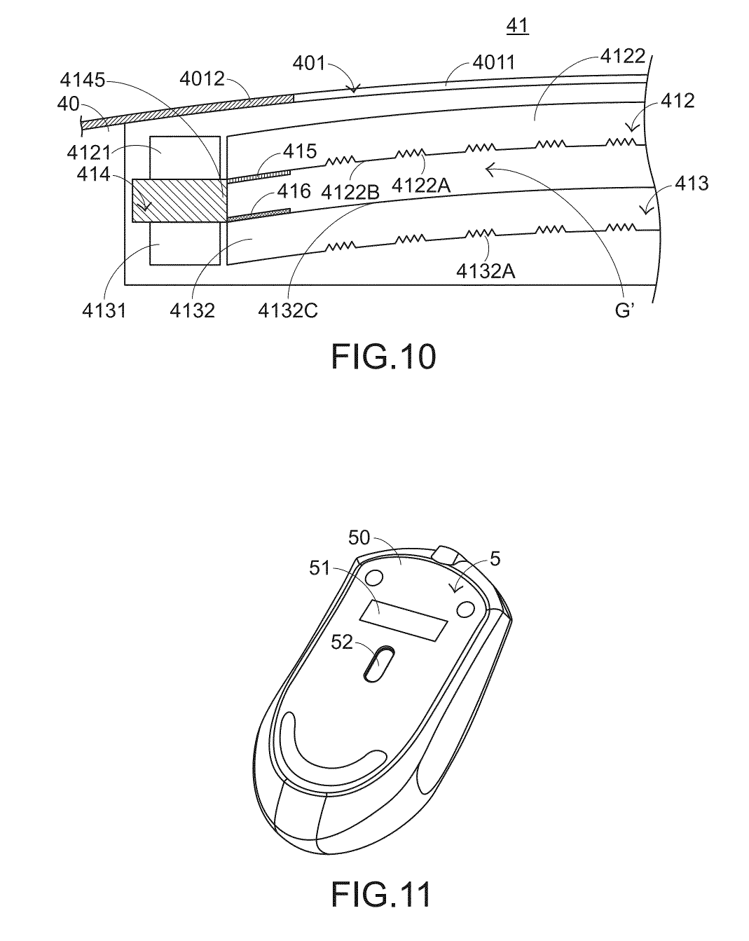

The present invention further provides a third embodiment. FIG. 9 is a schematic perspective view illustrating the outward appearance of a display device of an electrical apparatus according to a third embodiment of the present invention. FIG. 10 is a schematic side view illustrating the display device of the electrical apparatus according to the third embodiment of the present invention. The electrical apparatus 4 comprises a casing 40 and a display device 41. The casing 40 comprises a protective layer 401. In this embodiment, the electrical apparatus 4 is a Bluetooth earphone. As shown in FIG. 9, the display device 41 comprises a first illumination module 412, a second illumination module 413, a circuit board 414, a first light-shading structure 415, and a second light-shading structure 416. From bottom to top, the second illumination module 413, the second light-shading structure 416, the circuit board 414, the first light-shading structure 415, the first illumination module 412 and the protective layer 401 are sequentially shown.

The first illumination module 412 comprises a first light-emitting element 4121 and a first light guide plate 4122. The first light guide plate 4122 has a plurality of first luminous patterns 4122A. The second illumination module 413 comprises a second light-emitting element 4131 and a second light guide plate 4132. The second light guide plate 4132 has a plurality of second luminous patterns 4132A. The protective layer 401 is disposed over the first illumination module 412 for protecting the first illumination module 412. In addition, the protective layer 401 comprises a light-transmissible zone 4011 and a light-shading zone 4012.

Except for the following three items, the configurations and functions of the display device 41 of this embodiment are similar to those of the first embodiment, and are not redundantly described herein. Firstly, the first edge 4145 of the circuit board 414 is not inserted into the gap G′ between the first illumination module 412 and the second illumination module 413. Secondly, the display device 41 of this embodiment is additionally equipped with the first light-shading structure 415 and the second light-shading structure 416. The first light beam from the first light-emitting element 4121 is blocked by the first light-shading structure 415. Consequently, the first light beam is not transmitted through the gap G′ to influence the second illumination module 413. Moreover, the second light beam from the second light-emitting element 4131 is blocked by the second light-shading structure 416. Consequently, the second light beam is not transmitted through the gap G′ to influence the first illumination module 412. Thirdly, the display device 41 is installed on a curvy surface of the casing 40 of the electrical apparatus 4. Correspondingly, as shown in FIG. 10, the first light guide plate 4122 and the second light guide plate 4132 have curvy surfaces. In an embodiment, the first light guide plate 4122 and the second light guide plate 4132 are made of soft and flexible polycarbonate. In addition, the thickness of each of the first light guide plate 4122 and the second light guide plate 4132 is about 0.2˜0.4 mm.

Please refer to FIG. 10 again. The first light-shading structure 415 is disposed on a bottom surface 4122B of the first light-guiding plate 4122. Moreover, the first light-shading structure 415 is formed by painting, spraying, printing or bonding a light-shading material on the bottom surface 4122B of the first light-guiding plate 4122. The second light-shading structure 416 is disposed on a top surface 4132C of the second light-guiding plate 4132. Moreover, the second light-shading structure 416 is formed by painting, spraying, printing or bonding a light-shading material on the 4132C of the second light-guiding plate 4132. In this embodiment, the first light-shading structure 415 is a light-shading layer, which is formed by coating the bottom surface 4122B of the first light-guiding plate 4122 with light-shading ink. In addition, the second light-shading structure 416 is a light-shading tape, which is boned on the top surface 4132C of the second light-guiding plate 4132.

In this embodiment, the electrical apparatus 4 is a Bluetooth earphone. The display device 41 is used for displaying the brand logo of the Bluetooth earphone 4 or the playing status of an audio-generating device (e.g. a walkman, a CD player or any other song player) which is in communication with the Bluetooth earphone 4. For example, the first luminous patterns 4122A are arranged in a brand logo (e.g. “PRIMAX”), and the second luminous patterns 4132A are arranged in a specified character or symbol (e.g. “PLAYING”) to denote that the audio-generating device is playing.

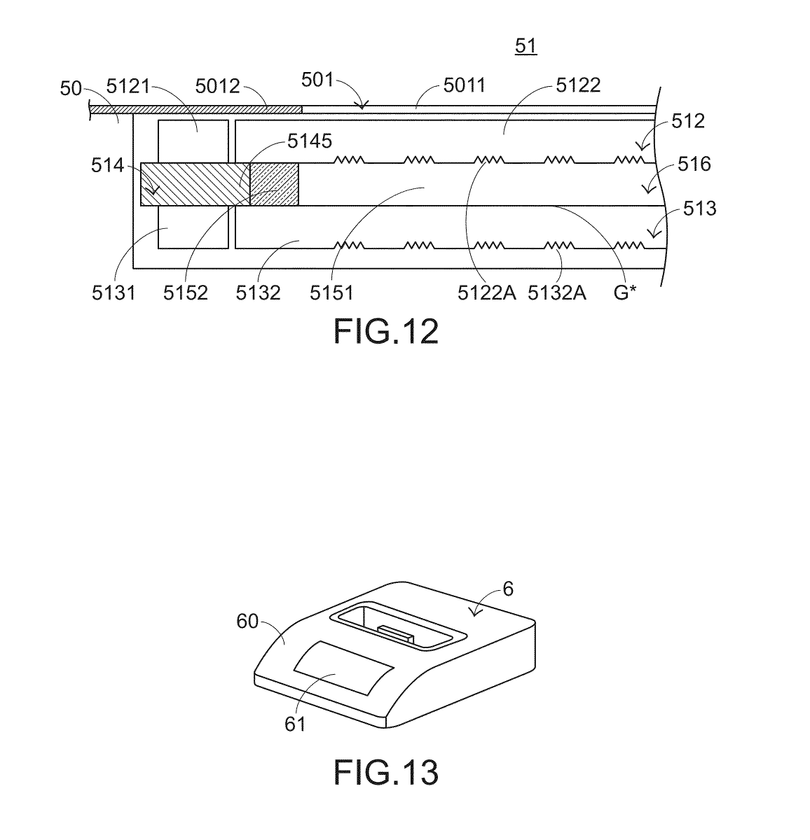

The present invention further provides a fourth embodiment. FIG. 11 is a schematic perspective view illustrating the outward appearance of a display device of an electrical apparatus according to a fourth embodiment of the present invention. FIG. 12 is a schematic side view illustrating the display device of the electrical apparatus according to the fourth embodiment of the present invention. As shown in FIG. 11, the electrical apparatus 5 comprises a casing 50 and a display device 51. The casing 50 comprises a protective layer 501. In this embodiment, the electrical apparatus 5 is a wireless mouse. In addition, the bottom surface of the casing 50 is a flat surface. As shown in FIG. 12, the display device 51 comprises a first illumination module 512, a second illumination module 513, a circuit board 514, and a light-shading structure 515. From bottom to top, the second illumination module 513, the circuit board 514 (or the light-shading structure 515), the first illumination module 512 and the protective layer 501 are sequentially shown.

The first illumination module 512 comprises a first light-emitting element 5121 and a first light guide plate 5122. The first light guide plate 5122 has a plurality of first luminous patterns 5122A. The second illumination module 513 comprises a second light-emitting element 5131 and a second light guide plate 5132. The second light guide plate 5132 has a plurality of second luminous patterns 5132A. The protective layer 501 is disposed over the first illumination module 512 for protecting the first illumination module 512. In addition, the protective layer 501 comprises a light-transmissible zone 5011 and a light-shading zone 5012.

In this embodiment, the light-shading structure 515 is disposed within a gap G* between the first light-guiding plate 5122 and the second light-guiding plate 5132. In addition, the light-shading structure 515 is located at a first side 5145 of the circuit board 514. The configurations and functions of other components of the display device 51 of this embodiment are similar to those of the third embodiment, and are not redundantly described herein. An example of the light-shading structure 515 includes but is not limited to a plastic sheet, a sponge structure or a light-shading plate.

In an embodiment, the light-shading structure 515 is a plastic sheet. In addition, the light-shading structure 515 comprises another light-transmissible zone 5151 and another light-shading zone 5152. The light-transmissible zone 5151 is aligned with the first luminous patterns 5122A and the second luminous patterns 5132A. Consequently, the first luminous patterns 5122A and the second luminous patterns 5132A are visible through the light-transmissible zone 5151. The light-shading zone 5151 is located at the first side 5145 of the circuit board 514 for blocking the first light beam and the second light beam that are emitted by the first light-emitting element 5121 and the second light-emitting element 5131. Consequently, the first light beam and the second light beam are not transmitted through the gap G* to influence the second illumination module 513 and the first illumination module 512. The display device 51 is used for displaying the resolution status of a displacement sensor 52 of the wireless mouse 5. For example, the first luminous patterns are arranged in a character “HIGH” to denote that the displacement sensor 52 has a high resolution, and the second luminous patterns are arranged in a character “LOW” to denote that the displacement sensor 52 has a low resolution.

The present invention further provides a fifth embodiment. FIG. 13 is a schematic perspective view illustrating the outward appearance of a display device of an electrical apparatus according to a fifth embodiment of the present invention. As shown in FIG. 13, the electrical apparatus 6 comprises a casing 60 and a display device 61. In this embodiment, the electrical apparatus 6 is a charger. In addition, the display device 61 is installed on a curvy surface of the casing 60. The configurations and functions of the display device 61 of this embodiment are similar to those of the second embodiment, and are not redundantly described herein. The display device 61 is used for displaying the brand logo of the charger 6 or the charging status of the charger 6. For example, the first luminous patterns are arranged in a brand logo (e.g. “PRIMAX”), and the second luminous patterns are arranged in a specified character symbol (e.g. “CHARGING”) to denote that the charging operation of the electrical apparatus 6 is being done. On the other hand, if the first luminous patterns and the second luminous patterns are not shown, the charging operation of the electrical apparatus 6 is stopped or has been completed.

The configurations of the display device 21 of the first embodiment may be applied to the display device 31 of the second embodiment. Alternatively, the configurations of the display device 41 of the third embodiment may be applied to the display device 31 of the second embodiment. Similarly, the configurations of the display device 51 of the fourth embodiment may be applied to the display device 31 of the second embodiment. Alternatively, the configurations of the display device 51 of the fourth embodiment may be applied to the display device 21 of the first embodiment. Similarly, the configurations of the display device 61 of the fifth embodiment may be applied to the display device 31 of the second embodiment. Alternatively, the configurations of the display device 61 of the fifth embodiment may be applied to the display device 21 of the first embodiment.

From the above description, the present invention provides a display device of an electrical apparatus. The display device utilizes only the light-emitting elements and at least two light guide plates to selectively display at least two luminous patterns without the need of installing a LCD panel and a control circuit therein. Consequently, the display device of the present invention not only has smaller thickness but also has lower fabricating cost. Moreover, for preventing the interference between the luminous patterns of two light guide plates, the display device of the present invention uses a circuit board or a light-shading structure to block the light beam from the adjacent light-emitting element, so that the luminous pattern of each light guide plate can be clearly viewed. Moreover, in a case that the first edge of the circuit board is inserted into the gap between the first light-guiding plate and the second light-guiding plate, the first light beam and the second light beam can be blocked by the first edge of the circuit board. Since no additional light-shading element is required, the fabricating cost can be further reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display device of an electrical apparatus, said electrical apparatus having a casing, said display device being installed on said casing, said display device comprising:
a first illumination module for emitting a first light beam, wherein said first illumination module comprises at least one first luminous pattern, wherein said at least one first luminous pattern is visible in response to said first light beam;
a second illumination module for emitting a second light beam, wherein said second illumination module is disposed under said first illumination module and comprises at least one second luminous pattern, wherein said at least one second luminous pattern is visible in response to said second light beam; and
a circuit board arranged between said first illumination module and said second illumination module, wherein a first edge of said circuit board is inserted into a gap between said first illumination module and said second illumination module for blocking said first light beam or said second light beam.

2. The display device according to claim 1, wherein said casing further comprises a protective layer, which is disposed over said first illumination module for protecting said first illumination module, wherein said protective layer comprises a light-transmissible zone and a light-shading zone, and said light-shading zone is located around said light-transmissible zone for shading said first light beam or said second light beam, wherein said at least one first luminous pattern or said at least one second luminous pattern is visible through said light-transmissible zone in response to said first light beam or said second light beam, and said light-transmissible zone has a preset light-shading percentage, wherein if said first light beam or said second light beam is not generated, said at least first luminous pattern of said first illumination module or said at least one second luminous pattern of said second illumination module is invisible according to said preset light-shading percentage.

3. The display device according to claim 2, wherein if said first light beam or said second light beam is not generated, an external light beam from surroundings of said display device is blocked by said light-shading zone according to said preset light-shading percentage, so that said at least one first luminous pattern or said at least one second luminous pattern is invisible, wherein said preset light-shading percentage is in a range between 75% and 80%.

4. The display device according to claim 1, wherein said first illumination module comprises a first light-emitting element and a first light-guiding plate, wherein said first light-emitting element is disposed on a first surface of said circuit board for emitting said first light beam, and said first light-guiding plate is stacked on said first surface of said circuit board and located at a first side of said first light-emitting element for guiding said first light beam, wherein said second illumination module comprises a second light-emitting element and a second light-guiding plate, said second light-emitting element is disposed on a second surface of said circuit board for emitting said second light beam, and said second light-guiding plate is stacked on said second surface of said circuit board and located at a first side of said second light-emitting element for guiding said second light beam.

5. The display device according to claim 4, wherein said first light guide plate further comprises at least one first opening, and said second light guide plate further comprises at least one second opening corresponding to said at least one first opening, wherein said at least one second opening is aligned with said at least one first opening, wherein said casing further comprises at least one positioning post corresponding to said at least one first opening and the at least one second opening, and said at least one positioning post is penetrated through said at least one first opening and the at least one second opening for fixing said first light guide plate and said second light guide plate on said casing.

6. The display device according to claim 4, wherein said first light-emitting element and said second light-emitting element are both side-view light emitting diodes, and said circuit board is parallel with said first light-guiding plate and said second light-guiding plate.

7. The display device according to claim 4, wherein said first light guide plate is made of polycarbonate or polymethyl methacrylate, and said at least one first luminous pattern is disposed on a top surface or a bottom surface of said first light guide plate, wherein said second light guide plate is made of polycarbonate or polymethyl methacrylate, and said at least one second luminous pattern is disposed on a top surface or a bottom surface of said second light guide plate, wherein each of said at least one first luminous pattern and said at least one second luminous pattern includes a plurality of closely packed light-guiding microstructures.

8. The display device according to claim 7, wherein if said top surface of said first light guide plate and said top surface of said second light guide plate are both flat surfaces, said first light guide plate and said second light guide plate are made of hard and non-flexible polycarbonate or hard polymethyl methacrylate, and each of said first light guide plate and said second light guide plate has a thickness of about 1 mm, wherein if said top surface of said first light guide plate and said top surface of said second light guide plate are both curvy surfaces, said first light guide plate and said second light guide plate are made of soft flexible polycarbonate or soft polymethyl methacrylate, and each of said first light guide plate and said second light guide plate has a thickness of about 0.2˜0.4 mm.

9. The display device according to claim 1, wherein a white glossy solder-proof ink layer is further formed on said circuit board for reflecting said first light beam or said second light beam, wherein said white glossy solder-proof ink layer is printed on a first surface and a second surface of said circuit board.

10. The display device according to claim 1, wherein said electrical apparatus is a mouse, a charger, a paper shredder, a Bluetooth earphone or a wireless keyboard.

11. A display device of an electrical apparatus, said electrical apparatus having a casing, said display device being installed on said casing, said display device comprising:
a first illumination module for emitting a first light beam, wherein said first illumination module comprises at least one first luminous pattern, wherein said at least one first luminous pattern is visible in response to said first light beam;
a second illumination module for emitting a second light beam, wherein said second illumination module is disposed under said first illumination module and comprises at least one second luminous pattern, wherein said at least one second luminous pattern is visible in response to said second light beam;
a circuit board arranged between said first illumination module and said second illumination module; and
a light-shading structure located at a first side of said circuit board and arranged between said first illumination module and said second illumination module for blocking said first light beam or said second light beam.

12. The display device according to claim 11, wherein said casing further comprises a protective layer, which is disposed over said first illumination module for protecting said first illumination module, wherein said protective layer comprises a light-transmissible zone and a light-shading zone, and said light-shading zone is located around said light-transmissible zone for shading said first light beam or said second light beam, wherein said at least one first luminous pattern or said at least one second luminous pattern is visible through said light-transmissible zone in response to said first light beam or said second light beam, and said light-transmissible zone has a preset light-shading percentage, wherein if said first light beam or said second light beam is not generated, said at least first luminous pattern of said first illumination module or said at least one second luminous pattern of said second illumination module is invisible according to said preset light-shading percentage.

13. The display device according to claim 12, wherein if said first light beam or said second light beam is not generated, an external light beam from surroundings of said display device is blocked by said light-shading zone according to said preset light-shading percentage, so that said at least one first luminous pattern or said at least one second luminous pattern is invisible, wherein said preset light-shading percentage is in a range between 75% and 80%.

14. The display device according to claim 11, wherein said first illumination module comprises a first light-emitting element and a first light-guiding plate, wherein said first light-emitting element is disposed on a first surface of said circuit board for emitting said first light beam, and said first light-guiding plate is stacked on said first surface of said circuit board and located at a first side of said first light-emitting element for guiding said first light beam, wherein said second illumination module comprises a second light-emitting element and a second light-guiding plate, said second light-emitting element is disposed on a second surface of said circuit board for emitting said second light beam, and said second light-guiding plate is stacked on said second surface of said circuit board and located at a first side of said second light-emitting element for guiding said second light beam.

15. The display device according to claim 14, wherein said first light guide plate further comprises at least one first opening, and said second light guide plate further comprises at least one second opening corresponding to said at least one first opening, wherein said at least one second opening is aligned with said at least one first opening, wherein said casing further comprises at least one positioning post corresponding to said at least one first opening and the at least one second opening, and said at least one positioning post is penetrated through said at least one first opening and the at least one second opening for fixing said first light guide plate and said second light guide plate on said casing.

16. The display device according to claim 14, wherein said first light-emitting element and said second light-emitting element are both side-view light emitting diodes, and said circuit board is parallel with said first light-guiding plate and said second light-guiding plate.

17. The display device according to claim 14, wherein said first light guide plate is made of polycarbonate or polymethyl methacrylate, and said at least one first luminous pattern is disposed on a top surface or a bottom surface of said first light guide plate, wherein said second light guide plate is made of polycarbonate or polymethyl methacrylate, and said at least one second luminous pattern is disposed on a top surface or a bottom surface of said second light guide plate, wherein each of said at least one first luminous pattern and said at least one second luminous pattern includes a plurality of closely packed light-guiding microstructures.

18. The display device according to claim 17, wherein if said top surface of said first light guide plate and said top surface of said second light guide plate are both flat surfaces, said first light guide plate and said second light guide plate are made of hard and non-flexible polycarbonate or hard polymethyl methacrylate, and each of said first light guide plate and said second light guide plate has a thickness of about 1 mm, wherein if said top surface of said first light guide plate and said top surface of said second light guide plate are both curvy surfaces, said first light guide plate and said second light guide plate are made of soft flexible polycarbonate or soft polymethyl methacrylate, and each of said first light guide plate and said second light guide plate has a thickness of about 0.2˜0.4 mm.

19. The display device according to claim 14, wherein said light-shading structure is disposed on a bottom surface of said first light-guiding plate or a top surface of said second light-guiding plate, wherein said light-shading structure is formed by painting, spraying, printing or bonding a light-shading material on said bottom surface of said first light-guiding plate or said top surface of said second light-guiding plate.

20. The display device according to claim 14, wherein said light-shading structure is a plastic sheet, a sponge structure or a light-shading plate, wherein said light-guiding structure is disposed within a gap between said first light-guiding plate and said second light-guiding plate and located at a first side of said circuit board.

21. The display device according to claim 11, wherein a white glossy solder-proof ink layer is further formed on said circuit board for reflecting said first light beam or said second light beam, wherein said white glossy solder-proof ink layer is printed on a first surface and a second surface of said circuit board.

22. The display device according to claim 11, wherein said electrical apparatus is a mouse, a charger, a paper shredder, a Bluetooth earphone or a wireless keyboard.
